(19) United States
(12) Patent Application Publication
(10) Pub. No.: US 2007/0013878 A1
(43) Pub. Date: Jan. 18, 2007

(54) Projector

(75) Inventors: Cheng-Feng Hsien, Miao Li County (TW); Ming-Cheng Lin, Miao Li County (TW)

Correspondence Address: BIRCH STEWART KOLASCH & BIRCH, PO BOX 747, FALLS CHURCH, VA, 22040-0747, US

(73) Assignee: Coretronic Corporation

(21) Appl. No.: 11/478,646

(22) Filed: Jul. 3, 2006

(30) Foreign Application Priority Data
Jul. 15, 2005 (TW) 94124050

(51) Int. Cl. G03B 21/20

(52) U.S. Cl. 353/85

(57) ABSTRACT

A projector for maintaining a bulb of the projector to generate a light at a constant luminance, the projector comprises a power gain data comprising a plurality of power values corresponding to a plurality of using-time durations, wherein the power value such as a voltage is supplied to the bulb is corresponding to the specific power value from the power gain data.

### BACKGROUND OF THE INVENTION

(1) Field of the Invention

The invention relates to a projector and a control method thereof, and more particularly to a method that can efficiently control a luminance of a bulb of a projector.

(2) Description of the Related Art

A projector is one most important display devices nowadays with advantages of magnifying images and easy to carry.

Please refer to FIG. 1, a bulb 4 is disposed within a projector for generating a light to project an image on a screen. A power supply device 2 provides a constant power to the bulb 4 according to a curve 10 on a diagram of power versus using-time duration, so that the luminance of the bulb 4 is getting lower as the using-time duration of the bulb 4 is getting longer, according to a curve 12 on a diagram of luminance versus using-time duration.

The projection efficiency of the projector decreases as lower and lower luminance occurs. Replacing the bulb 4 with a new bulb is one solution, but an extra charge for a producing cost is needed due to replacing the new bulb frequently.

### SUMMARY OF THE INVENTION

The object of the present invention is to provide a projector, which can maintain a constant luminance of a bulb of the projector through varying the power supplied to the bulb.

The present invention provides a projector comprising a bulb to generate a light at a constant luminance. The projector further comprises a power gain data, which comprises a plurality of power values corresponding to a plurality of using-time durations. According to a specific power value from the power gain data, a power is supplied to the bulb for maintaining the constant luminance.

The present invention provides a method for controlling a projector to maintain a bulb at a constant luminance through a pre-saved power gain data. The present invention is not only keeping a luminance efficiency of the projector but also increasing lifetime of the bulb within the projector.

### BRIEF DESCRIPTION OF THE DRAWINGS

The present invention will now be specified with reference to its preferred embodiment illustrated in the drawings, in which

FIG. 1 shows a diagram of power versus using-time duration and a diagram of luminance versus using-time duration according to a conventional projector;

FIG. 2 shows a schematic view of a projector and diagrams of curves related to the projector in the present invention;

FIG. 3 shows a flow chart of a method in the present invention for controlling luminance of a first bulb and a second bulb; and

FIG. 4 shows a further flow chart of a Step 08 in FIG. 3.

### DESCRIPTION OF THE PREFERRED EMBODIMENT

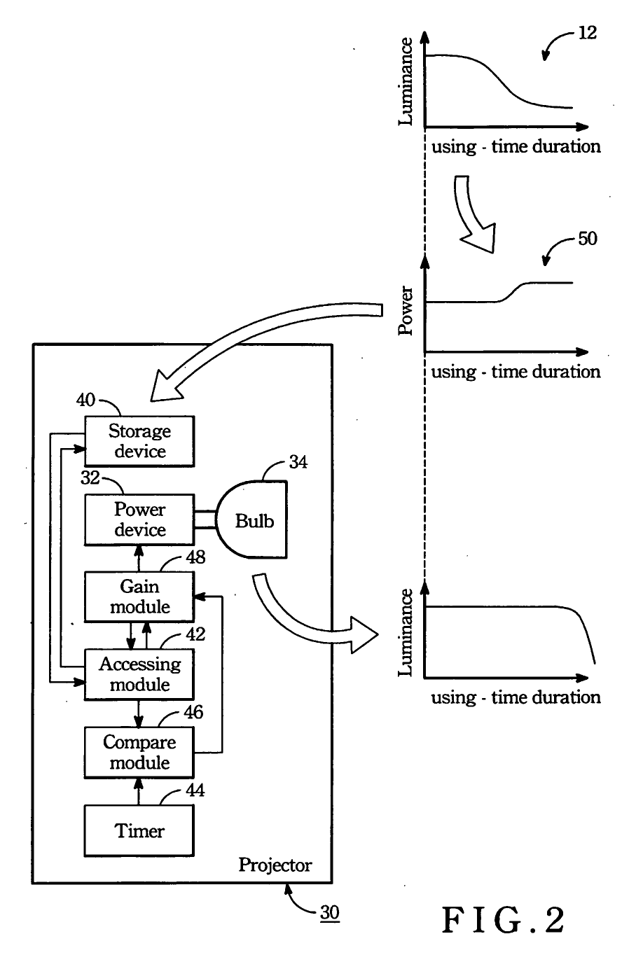

Please refer to FIG. 2. The projector 30 comprises a power device 32, a bulb 34, a storage device 40, an accessing module 42, a timer 44, a compare module 46, and a gain module 48. The power device 32 supplies a power that drives the bulb 34.

The storage device 40 is used for saving a power gain data 50, the power gain data 50 comprises a plurality of power values corresponding to a plurality of using-time durations for maintaining the bulb 34 at a constant luminance. Herein the material of the storage device 40 is not restricted to be a non-volatile random access memory such as a flash, an electrically erasable programmable read-only memory (EEPROM), an erasable programmable read-only memory (EPROM) or a hard disc for saving the power gain data 50 permanently.

The accessing module 42 is used for accessing the power gain data 50 from the storage device 40. The timer 44 produces a time data of the bulb 34, then the compare module 46 matches the time data from the timer 44 with the using-time duration of the power gain data 50 to find a specific using-time duration.

The gain module 48 accesses a specific power value corresponding to the specific using-time duration from the accessing module 42 and, the gain module 48 controls the power device 32 to supply a power to drive the bulb 34 according the specific power value. Therefore, the luminescence efficiency of the bulb 34 is stable until the bulb 34 is failed completely, but not influenced by the using-time duration. Herein the gain module 48 controls the power device 32 through varying a voltage that drives the bulb 34.

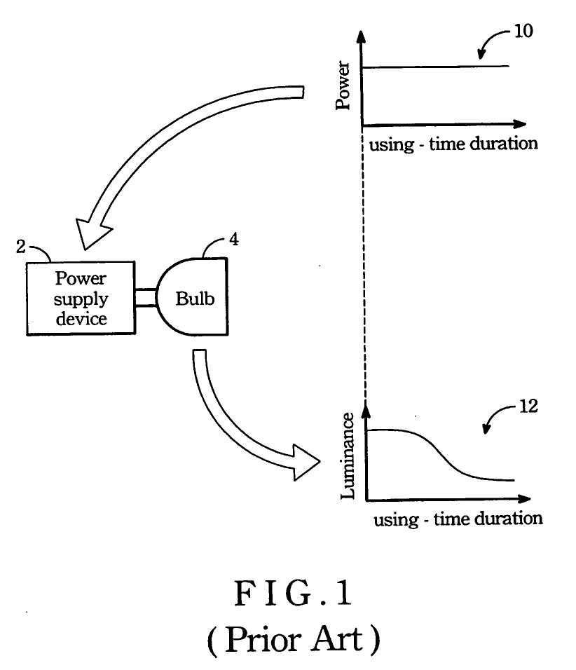

Further, the power gain data 50 is derived from a luminance decline data 12, which is expressed as the curve 12 of the luminance versus the using-time duration of the bulb 4 shown in FIG. 1. The luminance decline data 12 is derived through recording the real declination of one or more bulbs 34.

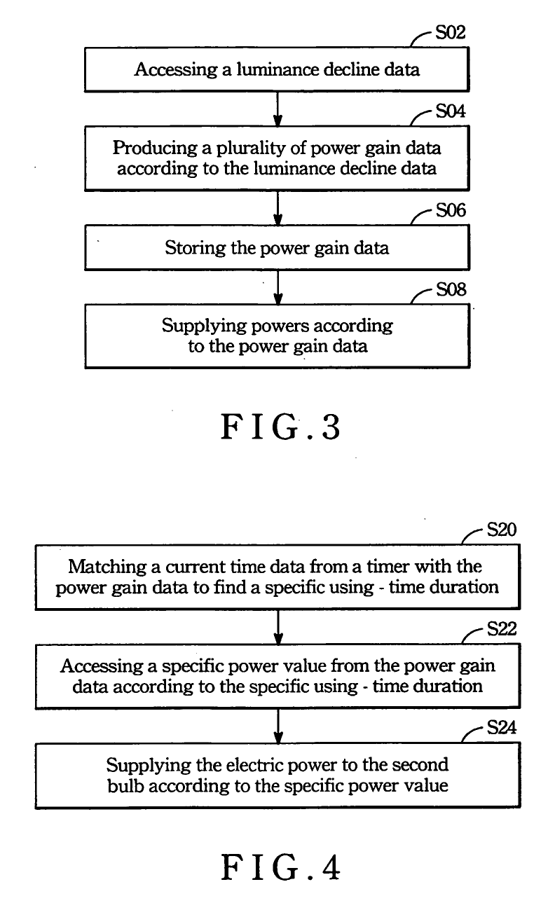

Please refer to FIG. 3, FIG. 3 shows a flow chart of a method in the present invention for controlling luminance of a first bulb and a second bulb. The bulb 34 is replaced with the first bulb or the second bulb for explaining. The first bulb is a test bulb, and the second bulb is positioned in the projector 30 for sale. Both the first bulb and the second bulb have the same electric standards.

The method comprises:

Step 02 (S02): accessing the luminance decline data 12, which comprising a plural of the luminance corresponding to a plural of the using-time duration of the first bulb;

Step 04 (S04): supplying a power for maintaining the first bulb to generate a light at a constant luminance according to the luminance decline data 12, and deriving a plurality of power gain data 50, which comprises a plurality of power values of the first bulb corresponding to a plurality of the using-time durations of the first bulb according to the luminance decline data 12;

Step 06 (S06): storing the power gain data 50;

Step 08 (S08): supplying a power for maintaining the second bulb to generate a light at a constant luminance according to the power gain data 50, wherein the power gain data 50 comprises power values corresponding to using-time durations of the first bulb. The power for maintaining the second bulb to generate a light at the constant luminance through varying the power value which is a voltage that drives the second bulb.

Please refer to FIG. 4. The method further comprises:

Step 20 (S20): the compare module 46 matching time data of the second bulb from a timer 14 with the power gain data 50 to find a specific using-time

Step 22 (S22): the accessing module 42 accessing a specific power value corresponding to the specific using-time duration of the second bulb from the power gain data 50;

Step 24 (S24): the gain module 48 controlling the power device 32 for supplying the specific power, a voltage, to the second bulb corresponding to the specific power value.

To sum up, the present invention provides a projector to maintain a constant luminance of the bulb thereof through a pre-saved power gain data. The present invention is not only keeping the luminance efficiency of the projector but also increasing lifetime of the bulb within the projector.

While the present invention has been particularly shown and described with reference to a preferred embodiment, it will be understood by those skilled in the art that various changes in form and detail may be without departing from the spirit and scope of the present invention.

We claim:

1. A projector comprising:
a storage device for saving a power gain data, the power gain data comprising a plurality of power values corresponding to a plurality of using-time durations for maintaining a bulb of the projector to generate lights at a constant luminance;
an accessing module for accessing the power gain data from the storage device;
a timer producing a time data of the bulb;
a compare module for matching the time data with the power gain data to find a specific using-time duration; and
a gain module accessing a specific power value corresponding to the specific using-time duration through the accessing module, and supplying a power to drive the bulb according to the specific power value.

2. The projector of claim 1, wherein the gain module controls a power device of the projector and the power device provides the power to drive the bulb.

3. The projector of claim 1, further comprising a luminance decline data comprising a luminance of the bulb corresponding to the using-time duration of the bulb, wherein the power gain data is derived from the luminance decline data.

4. The projector of claim 1, wherein the storage device is a Non-Volatile Random Access Memory (NVRAM).

5. The projector of claim 1, wherein the gain module varies the power value through varying a voltage to drive the bulb.

6. A method for controlling a luminance of a projector comprising a first bulb and a second bulb, the method comprising:
accessing a luminance decline data, comprising a luminance corresponding to a using-time duration of the first bulb;
supplying a power for maintaining the first bulb to generate a light at a constant luminance according to the luminance decline data and deriving a power gain data according to the luminance decline data;
storing the power gain data; and
supplying a power for maintaining the second bulb to generate a light at a constant luminance according to the power gain data, wherein the power gain data comprises a power value corresponding to a using-time duration of the first bulb.

7. The method of claim 6, wherein the power for maintaining the second bulb to generate the light at the constant luminance is varied through varying a voltage to drive the second bulb.

8. The method of claim 6, wherein the power gain data is stored in a Non-Volatile Random Access Memory (NVRAM).

9. The method of claim 6 further comprising:
matching a time data of the second bulb from a timer with the power gain data to find a specific using-time duration;
accessing a specific power value corresponding to the specific using-time duration of the second bulb from the power gain data; and
supplying a power to the second bulb corresponding to the specific power value.
